(19) United States
(12) Patent Application Publication
(10) Pub. No.: US 2013/0021151 A1
(43) Pub. Date: Jan. 24, 2013

(54) LOCATING UNIT AND LOCATING METHOD

(71) Applicant: Wolfgang Buchkremer, Grevenbroich (DE)

(72) Inventor: Wolfgang Buchkremer, Grevenbroich (DE)

(73) Assignee: KHS GmbH, Dortmund (DE)

(21) Appl. No.: 13/580,679

(22) PCT Filed: Mar. 16, 2011
(86) PCT No.: PCT/EP2011/001275

§ 371 Date: Oct. 11, 2012

(30) Foreign Application Priority Data
Mar. 30, 2010 (DE) 10 2010 013 657.3

(51) Int. Cl. G08B 1/08

(52) U.S. Cl. 340/539.1

(57) ABSTRACT

A method for locating a component that is part of an industrial installation and that has, on a surface thereof, a display unit that can be initiated by radio when required and that includes an organic light-emitting diode includes initiating the display unit by radio.

### TECHNICAL FIELD

The present invention relates to a method for locating at least one component as part of an industrial installation and a corresponding locating unit.

### BACKGROUND OF THE INVENTION

Industrial installations are often set up in a complex manner and usually consist of several machine sections or an agglomeration of functional units. Usually the machines or machine sections, in turn, also consist of a plurality of components wherein, usually, almost every component can be prone to defects and can thus lead to a reduction in performance or, at worst, to the total failure of the industrial installation. Because of this, it is necessary that the industrial installation is controlled and monitored at regular intervals to be able to ensure that, in the event of the occurrence of a defect, corresponding measures can be taken immediately or promptly. The finding of a defect or of a defective component is often difficult and time-consuming in complex industrial installations, so that it often cannot be avoided that, due to a defect, the industrial installation is not fully operational over a certain period.

It would thus be desirable, where a defect exists, to be able to locate it as quickly and easily as possible, to enable immediate measures to be taken if required.

In larger industrial installations, which are known and common in nearly all industry sectors, it is often advantageous to be able to permanently and continuously monitor, by means of mobile functional units, machines or components of the machines located in the industrial installation so that, in case a fault occurs, measures for remedying the fault can be taken as quickly and efficiently as possible or at least the machine affected can be shut down. Industrial installations for the manufacturing, processing, packaging, dismantling and cleaning etc. of products and goods have at least one but frequently several machine sections which can be combined as modules and have to be constantly monitored as regards their functionality.

Due to the often extensive collaboration of different machine sections or machines within an industrial installation, it would be desirable to be able to locate as quickly and efficiently as possible, by means of a mobile functional unit, defective components within the industrial installation, to then be able to either remove or at least repair the defective component as quickly as possible.

### SUMMARY OF THE INVENTION

To this end, the present invention proposes a method according to patent claim 1 which enables the fast locating of a defect on a component as part of an industrial installation. Also proposed are a corresponding component and an intelligent circuit with a computer program implemented thereon, enabling the implementation of a method proposed according to the invention for effectively locating a defect.

The dependent claims each describe further details of possible embodiments of the proposed method or of the proposed component.

According to patent claim 1, a method for locating at least one component as part of an industrial installation is proposed in which, on a surface of the at least one component, a radio-initiateable display unit is arranged which can be initiated by radio when required.

The radio-initiateable display unit can, for example, be an organic light-emitting diode (OLED).

To this end, the organic light-emitting diode is preferably arranged on a surface of the at least one component which faces outwards, i.e. which, in the properly installed condition, is in the field of vision of a person inspecting the industrial installation.

An organic light-emitting diode (OLED) usually is a thin-film luminous component made of organic semiconductor materials. At present, OLED technology is primarily used for screens such as television sets, PC screens and monitors and displays. Due to the flexible materials that can be used, an organic light-emitting diode can be used as a pliable screen. Thus, such an organic light-emitting diode is also suitable for being arranged on a component's surface that may not always be entirely flat.

Usually, organic light-emitting diodes are constructed of several organic layers. To this end, a so-called hole transport layer is applied to a layer acting as an anode and usually consisting of indium tin oxide, said layer in turn located on a glass layer. Between the indium tin oxide layer and the hole transport layer, another layer made of poly(3,4-ethylene dioxythiophene)/polystyrene sulfonate is usually applied. A layer which either contains the dye or entirely consists of the dye is applied onto the hole transport layer. This layer is usually called an emitter layer, namely the layer that ultimately emits light. Onto the emitter layer, an electron conductor layer is applied onto which ultimately a cathode is deposited as a final layer.

When a voltage is applied, an organic light-emitting diode emits light, the colour of which depends on what organic material is used for the emitter layer.

As an alternative to an organic light-emitting diode (OLED), a suitably adapted light emitting diode (LED) or liquid crystal display (LCD) can also be used if required. To this end, the LED and LCD must, if required, each be somewhat modified and/or extended with additional components. In the following description and the corresponding further details of the invention, an organic light-emitting diode (OLED) is used as an example and representation of all conceivable radio-initiateable display units.

According to a possible embodiment of the method according to the invention, a mobile radio transmission unit is used to initiate the organic light-emitting diode when required. This has the advantage that an operator, who inspects a corresponding industrial installation for defects which may have occurred to individual components, is very easily able to scan, using a mobile transmission unit, each of the individual components by means of the organic light-emitting diodes arranged on the components.

According to a further possible embodiment of the method according to the invention, the organic light-emitting diode is printed onto the surface of the component. However, it is possible to glue the organic light-emitting diode, by means of a suitable adhesive, onto the surface of the component. Any other possible and effective application of the organic light-emitting diode onto the surface of the component is also conceivable.

According to a further embodiment of the method according to the invention, it is envisaged that the organic light-emitting diode emits light in a signal colour in the event of the occurrence of a defect on the component following initiation by radio, for example using a mobile RF transmission unit. To this end, the light-emitting substance of the light-emitting diode can be selected such that the emitted signal colour is suitable for immediate recognition by the person operating the transmission unit, such as a bright red or a bright yellow. The colour is specified by the selection of the light-emitting material within the light-emitting diode. However, it is conceivable to envisage, as the light-emitting material in the organic light-emitting diode, several materials each of which emit a differently coloured light, said materials each being activated if required by applying different voltages, i.e. initiated for the emission of light. To this end, it would be possible that the respective component always emits light when initiated by radio; however, the colour of the emitted light depends on the fact of whether the component has a defect or not.

Instead of or in addition to purely a colour display, images such as bar codes, texts, films or the like can also be displayed.

According to a further possible embodiment of the method, it is envisaged to assign the component an intelligent circuit which causes the light-emitting diode to emit light in the signal colour in the event of the occurrence of a defect on the component following initiation by radio. To this end, it can be envisaged that the assigned intelligent circuit causes, if there is a defect to the component, the emission of light in a signal colour during initiation of the light-emitting diode while, in the normal condition, i.e. without defect, either no light or light of a neutral colour such as green is emitted.

The intelligent circuit assigned to the component can be implemented in the component or suitably connected with the component, e.g. arranged on the component. Moreover, it can be envisaged that the intelligent circuit is associated with a computer program which is preferably implemented in the intelligent circuit and, together with the intelligent circuit, causes the light-emitting diode to emit light in the signal colour in the event of the occurrence of a defect on the component following initiation by radio.

At least one conjugated polymer is used as a light-emitting material in the organic light-emitting diode, according to a further embodiment of the proposed method according to the invention. A conjugated polymer is a conductive polymer, this usually being organic macromolecules containing conjugated double bonds. To this end, the double bonds are arranged such that they always alternate with a single bond. The polymers consist of precisely lined-up light-emitting subunits, the so-called colour carriers, between which there is an interaction. The conjugated polymers have the advantage that they can be produced relatively easily and that it is possible to produce large and simultaneously pliable light-emitting diodes. Examples of conjugated polymers are poly(p-phenylene vinylene), polypyrrol, polyfluorene and polythiophene.

The present invention also relates to a component as part of an industrial installation in which, on a surface, a radio-initiateable display unit such as an organic light-emitting diode (OLED) is arranged which can be initiated by radio, when required, e.g. when checking for a fault that may have occurred.

According to an embodiment of the component, a mobile RF transmission unit can be used to initiate, when required, the radio-initiateable display unit such as an organic light-emitting diode.

It is conceivable that the radio-initiateable display unit, such as an organic light-emitting diode, is printed on the surface of the component. Any other possible application of the display unit such as an organic light-emitting diode, onto the surface of the component, so that the display unit can serve to locate the component, is however also conceivable.

According to a further embodiment of the component envisaged according to the invention, it is envisaged that the display unit, such as an organic light-emitting diode, emits light in a signal colour such as red or yellow in the event of the occurrence of a defect on the component following initiation by radio.

To this end, it is conceivable that the component is assigned an intelligent circuit which causes the display unit, such as an organic light-emitting diode, to emit light in the signal colour in the event of the occurrence of a defect on the component following initiation by radio. To this end, the intelligent circuit can be implemented in the component or also suitably coupled with the component.

As already mentioned, it is conceivable that at least one conjugated polymer is included as a light-emitting material for a light-emitting diode arranged on a surface of the component.

The following invention also relates to an intelligent circuit that is assigned to a component, as described above, and causes, with an implemented computer program with program code means, the radio-initiateable display unit such as an organic light-emitting diode, in the event of the occurrence of a defect on the component following initiation by radio, to emit light in a signal colour when the computer program is executed on a computer unit coupled to or interacting with the circuit.

The present invention also relates to a corresponding computer program which is saved on a computer-readable medium.

It is understood that the features mentioned above and yet to be explained below are not only usable in the particular given combination but also in other combinations or alone without departing from the scope of the present invention.

Further details and advantages of the invention result from the following descriptions of embodiments of the invention and the corresponding drawing.

The invention is schematically represented using an execution example and the drawing and is detailedly described below by reference to the drawing.

### BRIEF DESCRIPTION OF THE DRAWING

FIG. 1 shows a possible embodiment of a component proposed according to the invention with an organic light-emitting diode applied onto a surface of the component;

FIG. 2 shows a further possible embodiment of a component proposed according to the invention with an organic light-emitting diode applied onto a surface of the component and an RFID tag;

FIG. 3 shows a possible radio transmission unit with which a radio-initiateable display unit envisaged according to the invention, said display unit being arranged on a surface of a component, can be initiated;

FIG. 4 shows a further possible radio transmission unit which can be used, according to the invention, to initiate a radio-initiateable display unit arranged on a surface of a component.

### DETAILED DESCRIPTION OF THE DRAWING

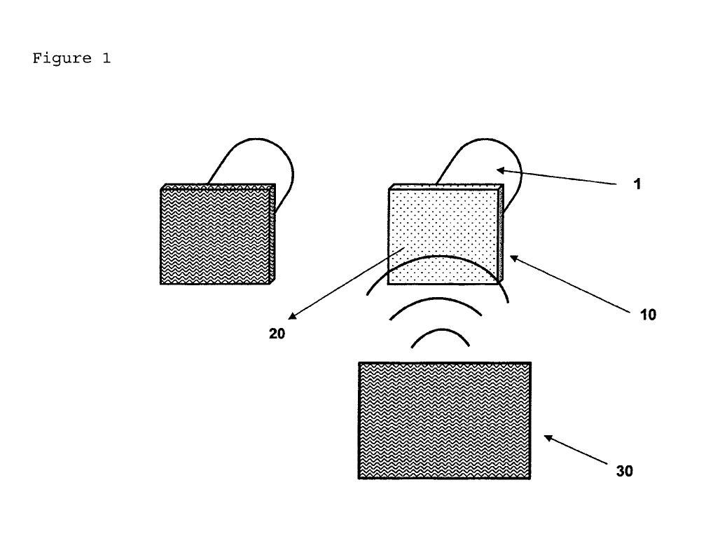

FIG. 1 shows a component 1 with an organic light-emitting diode 20 arranged on a surface 10 of the component 1. To this end, the light-emitting diode 20 can, for example, be printed or glued onto the surface 10. Any other suitable application method is also conceivable. Usually, the type of application depends on the consistency of the surface 10.

The light-emitting diode 20 generally consists of several organic layers wherein one, namely the emitter layer, comprises at least one light-emitting material. Ultimately, the choice of light-emitting material also determines the light colour in which the light-emitting diode emits light. According to the invention, it can be envisaged that the light-emitting diode, in case the component 1 has a defect, illuminates in a signal colour in order to directly alert a person, who examines a corresponding industrial installation for defects, to the defective component and to enable him or her to immediately take suitable measures if required.

It is conceivable that an intelligent circuit is envisaged, implemented in the component if required and coupled with the light-emitting diode so that, by means of this intelligent circuit, it becomes possible to control that the light-emitting diode illuminates in a signal colour when there is a defect and normally, i.e. without defect, either no light is emitted or light of a comparatively neutral colour is emitted. It is also conceivable that the intelligent circuit is associated with a computer program with program code means, said program causing, when it is executed on a corresponding computer unit, together with the circuit, as mentioned above, a suitable colour to be emitted by the light-emitting diode in case of a defect.

To this end, the light-emitting diode can be initiated by a mobile radio transmission unit.

Using such a mobile transmission unit, a person inspecting the industrial installation is able, in case the component is defective, to quickly recognise the defective component by the signal colour emitted. To this end, the person uses the radio transmission unit so that it thus scans the individual components from a certain distance.

It can also be envisaged that the OLED is arranged on a surface of a screw or of another fastening element, something which can be used for nearly all components of an industrial installation. To this end, the OLED then is best arranged on a head of the fastening means, so that the OLED, after fastening the fastening means to a corresponding component, is in visual contact with a person inspecting the corresponding industrial installation and, thus, can also be radio-initiated by the person. For this, the person concerned has, as also in the cases described above, a suitable mobile radio transmission unit 30, to be able to send electromagnetic waves in the direction of the OLED or in the direction of the component concerned.

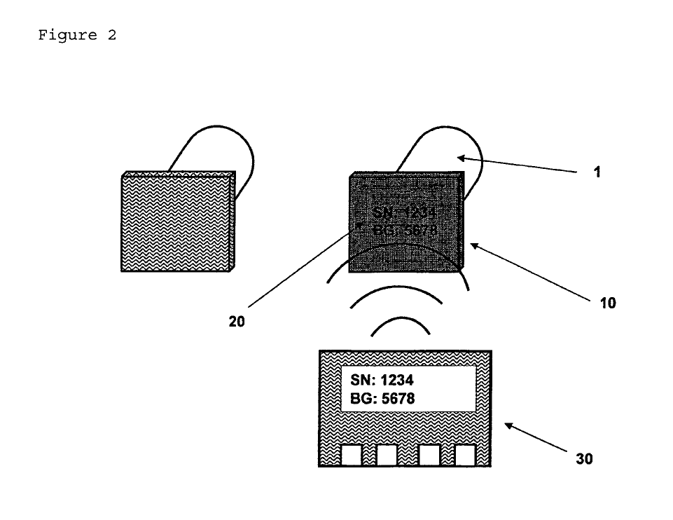

It can also be envisaged, as shown in FIG. 2, that a smart item such as in the form of an RFID tag, is arranged on the component in addition to the OLED, said smart item storing data relating to the component and said data also being available via the radio transmission unit 30. This can, for example, be a serial number or other component-specific data. This also simplifies an exchange of the corresponding component.

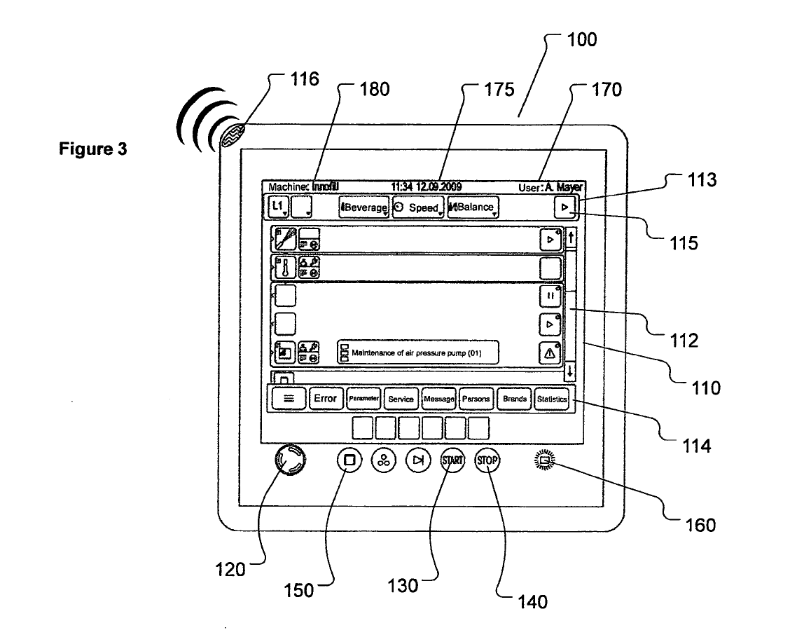

FIG. 3 shows a front view of a possible radio transmission unit which can be used to activate a radio-initiateable display unit envisaged according to the invention, said display unit being arranged on a surface of a component. The radio transmission unit 100 shown here has an approximately square shape with a side length in the region of about 15-35 cm. It has a display 110 which, for example, can be designed as a touch display (multitouch). In the lower area of the mobile radio transmission unit 100, on the left, a clearly marked button 120 that is enlarged compared with the other buttons is arranged, wherein pressing the same causes the triggering of an emergency stop of the corresponding machine incorporating the component. Moreover, a start button 130 and a stop button 140 are arranged in the lower area underneath the display 110. Furthermore, one or several buttons 150 are provided which can be defined by a user of the mobile radio transmission unit 100 or a person configuring the radio transmission unit 100 himself of herself or by means of which the user or the named person can undertake his or her own configurations of the radio transmission unit 100. A socket 160 provided in the lower right-hand area of the radio transmission unit 100 allows user access to the mobile radio transmission unit 100. In the top right of the display 110, in the embodiment shown as an example here, an identification 170 of a current user of the mobile radio transmission unit 100 is given. In the top middle of the display 110, a current date and a current time 175 are given. In the top left of the display 110, an identification 180 of a machine to be controlled is given which, for example, can be a name given to the machine to be controlled. The display 110 can be divided into different touch and display elements or fields. The display 110 shows, in the embodiment 100 shown in FIG. 3, a display field 111 in its middle, on which data for the user is displayed, wherein it can also be suitably marked in colour or highlighted in colour. Using specific colours, the data displayed, in addition to its pure content, can also give further associated information, wherein a meaning of a specific colouring must be known to the user. If required, the mobile radio transmission unit 100 also has an “auxiliary function” available which, for instance, also provides information relating to this meaning. The display 110, in the specific embodiment shown here, has a scrollbar 112 on the right-hand side. In the upper and lower area of the display 110 shown here, one toolbar 113 or 114 each is provided. Each of the toolbars 113 or 114 shows, using suitable symbols known to a user, different functions of the mobile radio transmission unit 100, wherein the particular functions can be activated by corresponding touch. In the embodiment 100 shown, at least the toolbar 113 can be also extended such as by touching an arrow symbol 115. The radio transmission unit 100 also comprises a transmitter 116, to initiate a radio-initiateable display unit arranged, according to the invention, on a surface of a component.

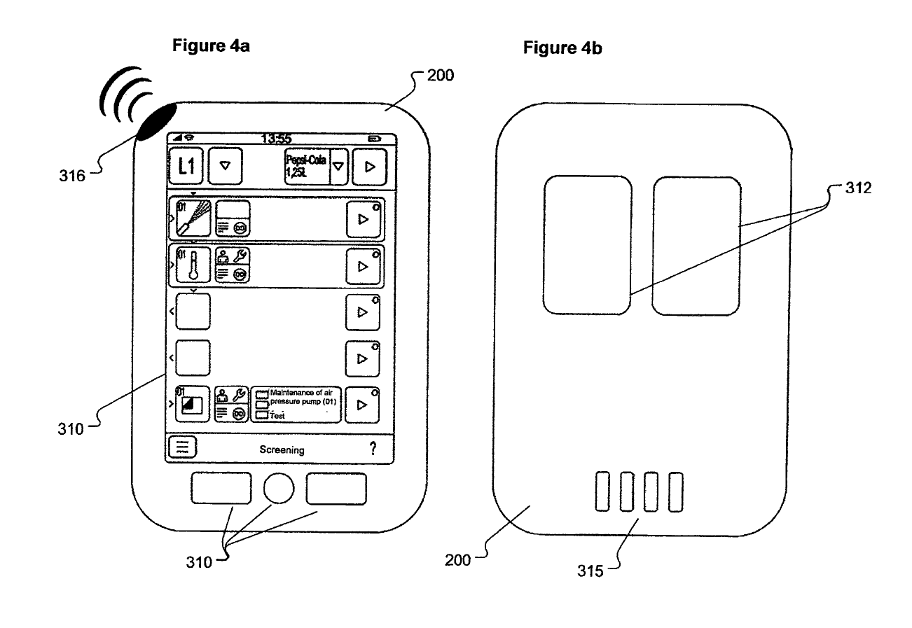

FIG. 4 shows a further embodiment 200 of a mobile radio transmission unit that can be used according to the invention. The radio transmission unit 200 shown here has a rectangular shape with a longitudinal side of about 10 to 20 cm and a broad side of about 5 to 15 cm. FIG. 4a shows a front view of the radio transmission unit 200, while FIG. 4b shows a rear view. The radio transmission unit 200 has a touch screen 310 enabling, by suitable touch, the direct entry of commands. Underneath the display 310, several navigation buttons 311 are provided which serve for navigation. On the rear of the radio transmission unit 200, as shown in FIG. 4b, interfaces 312 are shown. One of the interfaces 312 can, for example, be an RFID interface enabling a data exchange, in particular a reading out of an RFID tag, as can be provided on components of the machine to be controlled. Moreover, one of the interfaces 312 can also be a bar code interface enabling a reading in of a bar code as an identification, for example of a component. Furthermore, on the back, a supply 315 is provided by means of which the radio transmission unit 200 can be operated. Furthermore, the radio transmission unit 200 comprises a transmitter 316, to initiate a radio-initiateable display unit which, according to the invention, is arranged on a surface of a component.

1-12. (canceled)

13. A method for locating a component that is part of an industrial installation, said component having, on a surface thereof, a display unit that can be initiated by radio when required and that comprises an organic light-emitting diode, said method comprising initiating said display unit by radio.

14. The method of claim 13, wherein initiating said display unit by radio comprises using a mobile RF transmission unit to initiate said display unit when required.

15. The method of claim 13, wherein initiating said display unit by radio comprises initiating a display unit that is printed onto said surface of said component.

16. The method of claim 13, further comprising, following initiation by radio, causing said display unit to emit light in a signal color in response to occurrence of a defect on said component.

17. The method of claim 16, further comprising assigning to said component an intelligent circuit that, following initiation by radio, causes said display unit to emit light in said signal color in response to occurrence of a defect on said component.

18. An apparatus comprising a component that is part of an industrial installation, said component comprising a surface on which is provided a display unit that can be initiated by radio when required, said display unit comprising an organic light-emitting diode.

19. The apparatus of claim 18, further comprising a mobile RF transmission unit for initiating organic light-emitting diode when required.

20. The apparatus of claim 18, wherein said display unit is printed onto said surface of said component.

21. The apparatus of claim 18, wherein, in response to initiation by radio, said display unit is configured to emit light in a signal color in response to occurrence of a defect on said component.

22. The apparatus of claim 21, further comprising an intelligent circuit that, following initiation by radio, causes said display unit to emit light in said signal color in response to occurrence of a defect on said component.

23. The apparatus of claim 18, wherein said display unit comprises a conjugated polymer as a light-emitting material.

24. An apparatus comprising an intelligent circuit assigned to a component that is part of an industrial installation, said component having a surface on which is provided a display unit that can be initiated by radio when required, said display unit comprising an organic light-emitting diode, said intelligent circuit being configured to, using a computer program, cause said display unit to emit light in a signal color in response to occurrence of a defect on said component.
